(19) United States
(12) Patent Application Publication
(10) Pub. No.: US 2022/0362908 A1
(43) Pub. Date: Nov. 17, 2022

(54) WELDING PLIERS

(71) Applicant: ELCO ENTERPRISES, INC., JACKSON, MI (US)

(72) Inventors: EDWARD L. COOPER, CLARKLAKE, MI (US); NICHOLAS J. ZIEMAN, PARMA, MI (US)

(73) Assignee: ELCO ENTERPRISES, INC., JACKSON, MI (US)

(21) Appl. No.: 17/623,400

(22) PCT Filed: Jul. 9, 2020
(86) PCT No.: PCT/US2020/041406

§ 371 Date: Dec. 28, 2021

Related U.S. Application Data
(60) Provisional application No. 62/872,269, filed on Jul. 10, 2019.

(51) Int. Cl. B25B 7/02

(52) U.S. Cl. CPC B25B 7/02

(57) ABSTRACT

A welding plier includes a first handle and a second handle joined at a pivot point. A spring is disposed between the first and the second handle and biases the first handle away from the second handle. The welding plier also includes a first jaw that extends from the first handle and a second jaw that extends from the second handle. Interior surfaces of the first and second jaws are configured to come into contact with one another when a force is applied to the first handle and/or the second handle so as to overcome the biasing force provided by the spring. The exterior surface of the first jaw and the second jaw each form a step between eight terminal tip portion and a proximal portion.

### CROSS-REFERENCE TO RELATED APPLICATIONS

This PCT Application claims the benefit of priority under 35 U.S.C. § 119 to U.S. Patent Application No. 62/872,269, filed Jul. 10, 2019, the contents of which are incorporated herein by reference in their entirety.

### BACKGROUND

### 1. Field of the Invention

The present invention relates generally to hand tools; and more specifically to pliers best suited for use in bending consumable electrode wire used in welding processes such as gas metal arc welding systems.

### 2. Description of Related Art

Gas metal arc welding is an arc welding process in which a continuous and consumable wire electrode and shielding gas are fed through a welding gun. Generally, the consumable wire electrode is fed into a wire feed system from a spool. The wire feed system then frictionally engages the consumable wire electrode and moves it through a series of bearings and wire guides to the welding gun. As such, in order to feed the wire into the wire feed system, it is common for the wire to need to be bent at an end in order to form an eye. The eye can then be engaged by a tool such as a hook to pull on the wire. This is commonly required where there is a break in the wire, where a will station is been set up or where a continuous wire feed system is not used or operating correctly. In practice, the size and shape of this eye may be critical in order for the consumable wire to be properly fed into and fed through the wire feed system.

### SUMMARY

The present invention is a welding plier tool adapted for forming an eye in the consumable electrode wire end. The welding plier includes a first handle and a second handle joined at a pivot point. A spring is disposed between the first and the second handle and biases the first handle away from the second handle. The welding plier also includes a first jaw that extends from the first handle and a second jaw that extends from the second handle. Interior surfaces of the first and second jaws are configured to come into contact with one another when a force is applied by a user squeezing the handles together so as to overcome the biasing force provided by the spring. The exterior surface of the first jaw and the second jaw each terminate in a concave shape.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a prior art example of welding pliers;

FIG. 2 illustrates a consumable wire electrode having an and that terminates in an eye; and

FIG. 3 illustrates and improve welding plier having jaws that each have exterior surfaces that terminate with a concave shape.

### DETAILED DESCRIPTION

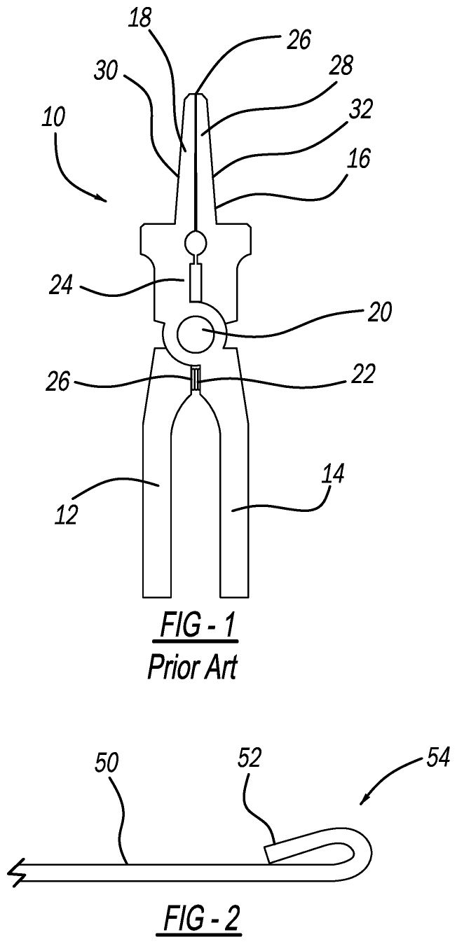

Referring to FIG. 1, a prior art welding plier 10 is shown. Here, the welding plier 10 includes a first handle 12 and a second handle 14 that are connected to each other at a pivot point 20. A spring 26 is located between the first handle 12 and the second handle 14 and provides a biasing force so as to bias the first handle 12 away from the second handle 14.

The first handle 12 has a jaw 16 that extends therefrom. The jaw 16 is located on the opposite side of the pivot point 20 from the handle 12. The second handle 14 also has a jaw 18 that extends therefrom as well. Like the jaw 16, the jaw 18 is located on the opposite side of the pivot point 20. As such, when the handles 12 and 14 are brought together by an operator by having the operator provide a force that is able to overcome the biasing force provided by the spring 26, the jaws 16 and 18 close in clamp against each other.

The jaw 18 also forms an inner surface 26 and exterior surface 30. The inner surface 26 is generally flat, while the exterior surface 30 is a radiused and generally forms a tapered shape as it terminates. The jaw 16, in like manner, also forms an inner surface 28 and an exterior surface 32. The inner surface 28 may be flat so as to mate with the inner surface 26 of the opposing jaw. Additionally, the inner surface 28 and/or the inner surface 26 may have a plurality of ridges so as to improve the gripping ability of the surfaces 26 and/or 28 when the jaws 16 and 18 are closed. Additionally, the exterior surface 32 forms a tapered type shape with rounded side edges.

Referring to FIG. 2, the consumable electrode wire 50 used for gas metal arc welding is shown. The wire 50 has a terminal and 52. When feeding the wire 50 into and pointed through a wire feed system, the terminal and 52 of the wire is bent over so as to form an eye 54. Generally, this is done using a pair of pliers, such as the pliers shown and described in FIG. 1. However, the shape of the jaws 16 and 18 of the pliers make it difficult to form the tightly shaped eye 54 shown in FIG. 2. Moreover, the shape of the jaw 16 and 18 have exterior surfaces 28 and 30 that each taper along their length. This configuration does not lend itself to providing eye 54 with a consistent radius of curvature and shape as shown in FIG. 2.

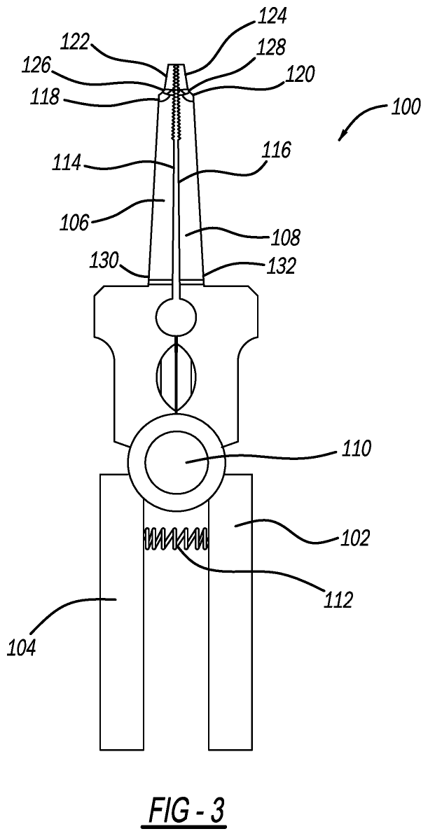

Referring to FIG. 3, an example of the improved welding pliers 100 in accordance with an embodiment of the present invention is shown. Here, the welding pliers 100 include a first handle 102 and a second handle 104 that are connected to each other via a pivot point 110. A spring 112 is located between the handles 102 and 104 and provide a biasing force biasing the handles 102 and 104 away from each other.

The handle 102 also has a jaw 106 that extends therefrom and is located opposite of the pivot point 110. The handle 104 has a jaw 108 that extends therefrom and is located opposite of the pivot point 110 as well. As such, when one brings the handles 102 and 104 together, the jaws 106 and 108 close to clamp against one another.

The jaw 106 has an interior surface 114 and exterior surface 118. The jaw 108 has an interior surface 116 and exterior surface 120. When closed, the interior surfaces 114 and 116 come to contact with one another. The interior surfaces 114 and 116 may be substantially flat or may have a plurality of ridges thereof, so as to enhance the gripping ability of the surfaces 114 and 160 when the jaws 106 and 108 are closed against wire 50.

The exterior surfaces 118 and 120 terminate at the distal tips of jaws 106 and 108 each with a rounded edge tip 122 and 124, which when the jaws 106 and 108 are closed, form a generally circular outer surface shape. Pronounced steps 126 and 128 are formed between edge tips 122 and 124 and proximal portions 130 and 132 of jaws 106 and 108 respectively. Tips 122 and 124 have a smaller lateral dimension and radiused dimension than the proximal portions 130 and 132 of the jaws closer to the pivot point 110. Thus the jaws have a stepped configuration with reduced dimension ends at tips 130 and 132. By utilizing a stepped configuration shape and thus creating much smaller tips, the pliers 100 can bend the consumable electrode wire into a much tighter eye shape at the terminal end. In addition the provision of steps 126 and 128 provide a guide for an operator to properly engage the wire to form the small diameter eye 54. This enables a more repeatable operation for forming the eye 54. The lateral dimensions of tips 122 and 124 are selected such that each of them will form eye 54 with the desired radius of curvature at its end.

In use an operator may grasp an end of wire 50 at near the distal end of jaws 116 and 118 and rotate pliers 100 about 180° to form eye 54. Ideally when grasping wire end 52 the end is flush with the edges of interior surfaces 114 and 116. This configuration provides for a repeated formation of eye 54 of a desire configuration.

As a person skilled in the art will readily appreciate, the above description is meant as an illustration of the principles of this invention. This description is not intended to limit the scope or application of this invention in that the invention is susceptible to modification, variation, and change, without departing from spirit of this invention, as defined in the following claims.

1. A welding plier adapted to form an eye in a consumable electrode wire comprising:
a first handle and a second handle, the first handle and second handle are joined at a pivot point;
a spring disposed between the first handle and the second handle, the spring being configured to bias the first handle and the second handle away from each other;
a first jaw extending from the first handle and a second jaw extending from the second handle, wherein each of the first jaw and the second jaw form an interior surface and an exterior surface;
wherein the interior surface of the first jaw and the interior surface of the second jaw are configured to come into contact with one another when a force is applied to the first handle and the second handle so as to overcome the bias provided by the spring; and
wherein the exterior surface of the first jaw and the exterior surface of the second jaw each form respective first and second steps between a respective first and second distal tips and respective first and second proximal portions, the tips having with a lateral dimension smaller than a lateral dimension of the proximal portions.

2. The welding plier in accordance with claim 1 further comprising the distal tips of each of the first and second jaws when closed against one another forming a generally circular outer circumferential shape.

3. The welding plier in accordance with claim 1 further comprising the interior surfaces of the first and second jaws forming a serrated surface for gripping the wire.

4. The welding plier in accordance with claim 1 further comprising the distal tips of each of the first and second jaws having a tapered configuration from the distal end to the steps.

5. A method of forming an eye adjacent to an end of a consumable electrode wire used in a welding process comprising:
providing welding pliers having a first handle and a second handle, the first handle and second handle are joined at a pivot point; a spring disposed between the first handle and the second handle, the spring being configured to bias the first handle and the second handle away from each other, a first jaw extending from the first handle and a second jaw extending from the second handle, wherein each of the first jaw and the second jaw form an interior surface and an exterior surface, wherein the interior surface of the first jaw and the interior surface of the second jaw are configured to come into contact with one another when a force is applied to the first handle and the second handle so as to overcome the bias provided by the spring; wherein the exterior surface of the first jaw and the exterior surface of the second jaw form a step between respective first and second distal tips and respective first and second proximal portions, the tips having with a lateral dimension smaller than a lateral dimension of the proximal portions;
grasping the wire adjacent to the end between the interior surfaces of the first jaw and the second jaw in the region of the distal tips; and
rotating the pliers about 180° to form the eye wherein the welding wire wraps around one of the distal tips.

6. The method according to claim 5 further comprising the step of positioning an end of the welding wire adjacent to an outer edge of the interior surfaces of the tips when the grasping the wire step.
